(19) United States
(12) Patent Application Publication
(10) Pub. No.: US 2009/0274305 A1
(43) Pub. Date: Nov. 5, 2009

(54) METHOD AND APPARATUS FOR TRANSMITTING CONTENT KEY

(75) Inventors: Sun-nam LEE, Suwon-si (KR); Choong-hoon LEE, Seoul (KR); Young-sun YOON, Suwon-si (KR); Hak-soo JU, Suwon-si (KR); Jin-mok KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/271,379

(22) Filed: Nov. 14, 2008

(30) Foreign Application Priority Data
May 2, 2008 (KR) 10-2008-0041484

(51) Int. Cl. H04L 9/00

(52) U.S. Cl. 380/279

(57) ABSTRACT

Provided is a method of transmitting content keys to nodes arranged in a hierarchical structure which includes a plurality of node groups each including a predetermined number of the nodes. In this method, revoke information that includes identifiers of revoked node groups in the hierarchical structure, the total number of independent revoked nodes, and identifiers of the independent revoked nodes is generated. The revoked node groups are node groups consisting of only revoked nodes, and the independent revoked nodes are revoked nodes not belonging to any of the revoked node groups. Then, encrypted content keys are obtained by encrypting content keys using broadcast encryption, by using an encryption key set that has a form that cannot be generated using a decryption key set that the revoked nodes possess, and a set of encrypted content keys is generated. Thereafter, the revoke information and the set of the encrypted content keys are transmitted to all of the nodes arranged in the hierarchical structure.

### CROSS-REFERENCE TO RELATED PATENT APPLICATION

This application claims priority from Korean Patent Application No. 10-2008-0041484, filed on May 2, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to transmitting a content key, and more particularly, to transmitting a content key in a broadcast encryption system.

2. Description of the Related Art

Broadcast encryption (BE) is a method of effectively transmitting information by a transmitter, such as a server or a broadcasting center, to only desired users from among all users. BE should be able to be effectively used when a group of users, who are to receive information, changes arbitrarily and dynamically.

FIG. 1 is a diagram for describing a principle in which a server node in a BE system allocates a key to each node.

Referring to FIG. 1, a node 0, a node 1, a node 2, and a node 3 are linearly arrayed and connected to the server node. A set of nodes, such as the node 0, the node 1, the node 2, and the node 3, is referred to as a node group.

The server node corresponds to a server (for example, a broadcasting center), and the node 0, the node 1, the node 2, and the node 3 correspond to devices for reproducing contents in the BE system.

Each node i is allocated with a random node key Si, where i is a positive integer. In other words, the node 0 is allocated with node key S0, the node 1 is allocated with node key S1, the node 2 is allocated with node key S2, and the node 3 is allocated with node key S3. Each of the node 0, the node 1, the node 2, and the node 3 includes not only an allocated node key but also a group of decryption keys that are generated by consecutively applying one-way hash functions to the node key corresponding to each node.

FIG. 2 illustrates an example of a set of decryption keys allocated to each node in the BE system illustrated in FIG. 1. In FIG. 2, h denotes a one-way hash function, and h²(S0) is equal to h(h(S0)).

In the example of FIG. 1, if the node 3 is revoked, the server may generate an encrypted content key E(h²(S0, cK)) into which a content key cK is encoded by using an encryption key h²(S0), and transmit the encrypted content key E(h²(S0, cK)) to the node 0, the node 1, the node 2, and the node 3. In this case, the node 0, the node 1, and the node 2 store the encryption key h²(S0) or a group of decryption keys that can generate the encryption key h²(S0). However, the node 3 cannot calculate the encryption key h²(S0) from a decryption key h³(S0) which the node 3 itself stores, because a one-way hash function cannot obtain an input value from a given output value. In order to process a large number of nodes, the structure illustrated in FIG. 1 needs to be hierarchical.

FIG. 3 illustrates a hierarchy of the node group illustrated in FIG. 1.

The hierarchy of FIG. 3 is comprised of four layers, namely, a zero-th layer, a first layer, a second layer, and a third layer. Each of node groups that constitute each layer includes four nodes. As in the example of FIG. 2, each of the four nodes is allocated with a group of decryption keys that are generated by a hash function.

In the hierarchy of FIG. 3, it should be noted that each node stores a group of decryption keys for the node itself, whereas each node on the lowest layer stores a group of decryption keys that have been allocated to parent nodes that constitute upper layers of the lowest layer to which the each node belongs. In addition, when a node is revoked, parent nodes of the revoked node are considered revoked.

When the server transmits an encryption key to each node, the server also transmits information about revoked nodes so that each node can obtain information about the encryption key.

FIG. 4 illustrates an example of a related art key block constructed so as to restrict the use of content by the revoked nodes illustrated in FIG. 3. In FIG. 3, nodes indicated by circles are normal nodes, and nodes indicated by rectangles are revoked nodes.

In FIG. 4, BKB-Len denotes length information that indicates the length of the entire data included in the related art key block, KCD denotes key check data used to check the integrity of a content key, and “Revoked Leaf Nodes E=4” indicates that the number of revoked nodes is 4.

Binary numbers on the second and third lines indicate identifiers of the revoked nodes. <Sig> on the fourth line indicates an electronic signature for the BKB-Len, the KCD, and the number of revoked nodes. The content on the fourth through eighth lines indicates a set of encrypted content keys. For example, E(S2 of the first group in Layer 0), bK) indicates an encrypted content key created by encrypting a content key bK by using a node key S2 of a first group on the zero-th layer. Strictly speaking, the content key bK is a block key bK, but it is identical to a content key in that the block key bK is used to encrypt content. Thus, it is hereinafter assumed that bK is referred to as a content key.

Table 1 shows a result obtained by summarizing the identifiers of the revoked nodes illustrated in FIG. 3 according to the layers of the hierarchy. Each column denotes each layer of the hierarchy.

TABLE 1

| | | | | | | | |
|---|---|---|---|---|---|---|---|
| 0 | 0 | 0 | 1 | 0 | 3 | 0 | 3 |
| 0 | 2 | 1 | 1 | 0 | 1 | 0 | 1 |
| 0 | 1 | 1 | 1 | 0 | 2 | 0 | 2 |
| 3 | 0 | 0 | 0 | 1 | 1 | 1 | 2 |

In Table 1, second, fourth, sixth, and eighth columns indicate the identifiers of the revoked nodes illustrated in FIG. 3, and first, third, fifth, and seventh columns indicate tags for indicating additional information about the revoked nodes of the second, fourth, sixth, and eighth columns, respectively. For example, 0210 is an identifier indicating that the node 0 on the zero-th layer is revoked, the node 2 on the first layer is revoked, the node 1 on the second layer is revoked, and the node 0 on the third layer is revoked.

Tags are newly indicated for each layer, and a principle in which tags are indicated is as follows. In each layer, a tag for the revoked node on the second column is marked with 0 as a default. In each layer, if parent nodes of the revoked nodes on the second and fourth columns are the same, a tag for the revoked node on the fourth column is marked with 0, which is the same value as 0 which is a value of the tag for the revoked node on the second column. On the other hand, if the parent nodes of the second and fourth columns are different from each other, a tag for the revoked node on the fourth column is marked with 1, which is a value different from 0 which is the value of the tag for the revoked node on the second column. Similarly, in each layer, when the tag for the revoked node on the fourth column is marked with 1, if parent nodes of the revoked nodes on the fourth and sixth columns are the same, a tag for the revoked node on the sixth column is marked with 1, which is the same value as 1 which is the value of the tag for the revoked node on the fourth column. On the other hand, if the parent nodes of the revoked nodes on the fourth and sixth columns are different from each other, the tag for the revoked node on the sixth column is marked with 0, which is a value different from 1 which is the value of the tag for the revoked node on the fourth column. Here, it should be noted that when all of the nodes that constitute a node group are revoked, a tag for the revoked node located at the first position within the node group is marked with a value obtained by subtracting 1 from the total number of revoked nodes that constitute the node group. For example, in Table 1, since four nodes constitute a single node group, a tag for a revoked node located at the first position within a node group comprised of only revoked nodes, namely, the tag for the revoked node on the second column, is marked with 3.

The identifiers of the revoked nodes on the second and third lines of FIG. 4 are binary values in which combinations of the tags with the revoked node identifiers shown in Table 1 are represented according to the four layers. For example, a first row 00010303 of Table 1 is represented as 0000₂, 0001₂, 0011₂, 0011₂ in FIG. 4.

As described above, in the related art, the size of a key block cannot be effectively reduced because revoked nodes are identified and distinguished from one another by using both their identifiers and tags.

### SUMMARY OF THE INVENTION

The present invention provides a method and apparatus for transmitting content keys, in which the contents are transmitted to nodes included in a BE system by using a key block having a smaller size as compared with that of the related art.

According to an aspect of the present invention, there is provided a method of transmitting content keys to nodes included in a hierarchical structure which includes a plurality of node groups each comprising a predetermined number of the nodes, the method comprising: generating revoke information that comprises identifiers of revoked node groups in the hierarchical structure, the total number of independent revoked nodes, and identifiers of the independent revoked nodes, wherein the revoked node groups are node groups comprised of only revoked nodes and the independent revoked nodes are revoked nodes not belonging to any of the revoked node groups; generating a set of encrypted content keys that are obtained by encrypting content keys, according to a broadcast encryption method, by using an encryption key set that has a form that cannot be generated using a decryption key set that the revoked nodes possess; and transmitting the revoke information and the set of the encrypted content keys to all of the nodes included in the hierarchical structure.

The generating of the revoke information may further include: generating a single identifier list by integrating the identifiers of the independent revoked nodes with the identifiers of the revoked node groups; and generating indices that represent the orders in which the identifiers of the revoked node groups are located within the identifier list. The revoke information may comprise the identifier list, the indices, and the total number of revoked nodes.

The revoke information may further comprise the total number of revoked node groups, and the total number of independent revoked nodes may represent the number of revoked nodes other than revoked nodes belonging to the revoked node groups.

The identifier of each of the revoked node groups may be generated using an identifier of a revoked node from among the revoked nodes that constitute each of the revoked node groups.

The generating of the revoke information may comprise: when each of the node groups is comprised of N nodes, sequentially allocating numbers 0 through (N−1) to the N nodes of each of the node groups in each layer of the hierarchical structure; and generating the identifiers of the revoked node groups and the identifiers of the independent revoked nodes by combining numbers allocated to all of the nodes on the uppermost layer through to the lowermost layer of the hierarchical structure in such a way that a number allocated on the uppermost layer through to a number allocated on the lowermost layer are sequentially combine

In the transmitting, key check data, which is hash values of the content keys, the revoke information, the set of the encrypted content keys, data length information representing the overall length of the key check data, and an electronic signature for the key check data, the revoke information, and the data length information may be further transmitted.

The method may further comprise detecting revoked nodes from the nodes included in the hierarchical structure.

If the nodes have been allocated with random node keys, the encryption key set may be comprised of encryption keys obtained by performing a smaller number of hash operations on identical random node keys than the number of hash operations performed to obtain decryption keys included in the decryption key group.

The identifiers of the revoked node groups, the total number of independent revoked nodes, and the identifiers of the independent revoked nodes may be generated by using one of a binary number, a quaternary number, and a hexadecimal number.

In the transmitting, a key block comprising the revoke information and the set of the encrypted content keys may be transmitted to all of the nodes included in the hierarchical structure.

According to another aspect of the present invention, there is provided an apparatus for transmitting content keys to nodes arranged in a hierarchical structure which includes a plurality of node groups each comprising a predetermined number of the nodes, the apparatus comprising: a revoke information generation unit generating revoke information that comprises identifiers of revoked node groups in the hierarchical structure, the total number of independent revoked nodes, and identifiers of the independent revoked nodes, wherein the revoked node groups are node groups comprised of only revoked nodes and the independent revoked nodes are revoked nodes not belonging to any of the revoked node groups; a key generation unit generating a set of encrypted content keys that are obtained by encrypting content keys, according to a broadcast encryption method, by using an encryption key set that has a form that cannot be generated using a decryption key set that the revoked nodes possess; and a transmission unit transmitting the revoke information and the set of the encrypted content keys to all of the nodes arranged in the hierarchical structure.

According to another aspect of the present invention, there is provided a computer-readable recording medium having recorded thereon a program for executing the above-described method of transmitting content keys to nodes arranged in a hierarchical structure which includes a plurality of node groups each comprising a predetermined number of the nodes, the method comprising: generating revoke information that comprises identifiers of revoked node groups in the hierarchical structure, the total number of independent revoked nodes, and identifiers of the independent revoked nodes, wherein the revoked node groups are node groups comprised of only revoked nodes and the independent revoked nodes are revoked nodes not belonging to any of the revoked node groups; generating a set of encrypted content keys that are obtained by encrypting content keys, according to a broadcast encryption method, by using an encryption key set that has a form that cannot be generated using a decryption key set that the revoked nodes possess; and transmitting the revoke information and the set of the encrypted content keys to all of the nodes arranged in the hierarchical structure.

### BRIEF DESCRIPTION OF THE DRAWINGS

The above and other aspects of the present invention will become more apparent by describing in detail exemplary embodiments thereof with reference to the attached drawings in which:

FIG. 1 is a diagram for describing a principle in which a server in a BE system allocates a key to each node according to the related art;

FIG. 2 illustrates an example of a set of decryption keys allocated to each node in the BE system illustrated in FIG. 1 according to the related art;

FIG. 3 illustrates a hierarchy of a node group of the BE system illustrated in FIG. 1 according to the related art;

FIG. 4 illustrates an example of a related art key block constructed to restrict the use of content by revoked nodes of the BE system illustrated in FIG. 3;

FIG. 5 is a flowchart of a content key transmitting method according to an exemplary embodiment of the present invention;

FIG. 6 illustrates a key block constructed to restrict the use of the content of the revoked nodes of the BE system illustrated in FIG. 3, according to an exemplary embodiment of the present invention;

FIG. 7 illustrates a key block constructed to restrict the use of the content of the revoked nodes of the BE system illustrated in FIG. 3, according to another exemplary embodiment of the present invention;

FIG. 8 is a block diagram of a content key transmitting apparatus according to an exemplary embodiment of the present invention; and

FIG. 9 illustrates a difference between the amount of data included in a transmitted key block according to the present invention and the amount of data included in a transmitted related art key block, according to the number of revoked nodes.

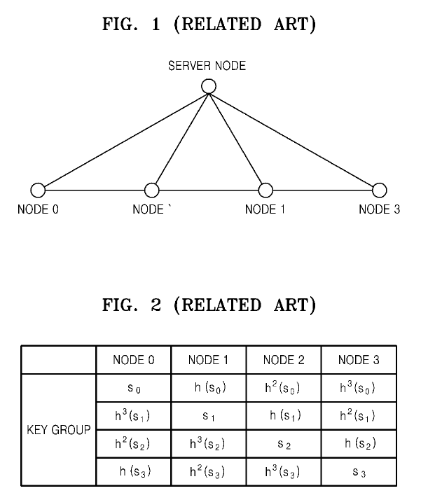

### DETAILED DESCRIPTION OF EXEMPLARY EMBODIMENTS OF THE INVENTION

The present invention will now be described more fully with reference to the accompanying drawings, in which exemplary embodiments of the invention are shown.

FIG. 5 is a flowchart of a content key transmitting method according to an exemplary embodiment of the present invention.

In operation 510, revoke information including identifiers of revoked node groups each of which is only comprised of revoked nodes, the total number of independent revoked nodes, namely, revoked nodes not belonging to any of the revoked node groups, and identifiers of the independent revoked nodes are generated in a hierarchical structure including a plurality of node groups each including a predetermined number of the nodes.

In other exemplary embodiments, the revoke information may further include the total number of revoked node groups.

In the related art, identifiers of revoked node groups are indicated by using tags, without allocating the identifiers of revoked node groups separately from the identifiers of independent revoked nodes as described above. However, as described above, the related art requires as many tags as identifiers, thereby leading to an increase in the size of revoke information.

However, in the present invention, the identifiers of the independent revoked nodes are distinguished from the identifiers of the revoked node groups without using tags. Thus, the present invention can reduce the size of revoke information as compared with the related art.

Operation 510 is performed on the assumption that revoked nodes among the nodes arranged in the hierarchical structure have been detected. If the revoked nodes have not been detected, an operation of detecting revoked nodes from the nodes arranged in the hierarchical structure may be performed prior to operation 510.

In operation 520, content keys are encrypted using an encryption key group having a form that cannot be generated using a decryption key group that the revoked nodes possess, according to a BE method, and a group of the encrypted content keys is generated. When the nodes have been allocated with random node keys, the encryption key group is comprised of encryption keys obtained by performing a smaller number of hash operations on identical random node keys than the number of hash operations performed to obtain decryption keys included in the decryption key group. For example, if a revoked node has a decryption key h³(S0), the revoked node cannot generate encryption keys such as S0, h(S0), and h²(S0). In operation 520, a content key bK is encrypted using one of the encryption keys S0, h(S0), and h²(S0), based on the above-described feature that a revoked node cannot generate such encryption keys as S0, h(S0), and h²(S0), thereby generating the encrypted content keys. The generation of the encrypted content keys according to the BE method in operation 520 has already been described and is known to those of ordinary skill in the art to which the present invention pertains, so a detailed description thereof will be omitted.

In operation 530, the revoke information and the group of encrypted content keys are transmitted to each of the nodes arranged in the hierarchical structure.

At this time, the revoke information and the group of encrypted content keys may be transmitted separately, but a key block including the revoke information and the group of encrypted content keys may be transmitted to each of the nodes.

The revoke information may be stored in a header of a data packet and then transmitted. For example, the header of the data packet includes a field for identifiers of revoked node groups, a field for information about the total number of independent revoked nodes, and a field for identifiers of the independent revoked nodes. The data packet having the header which stores the revoke information in corresponding fields may be transmitted to each of the nodes.

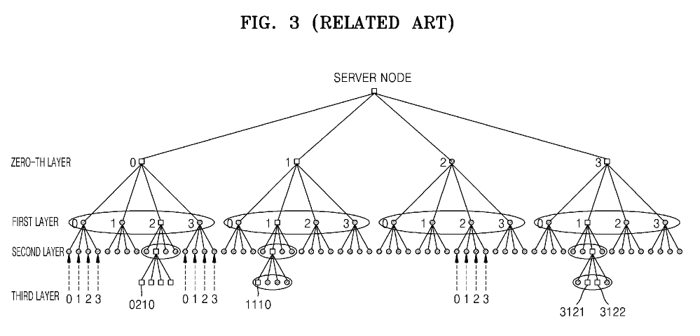

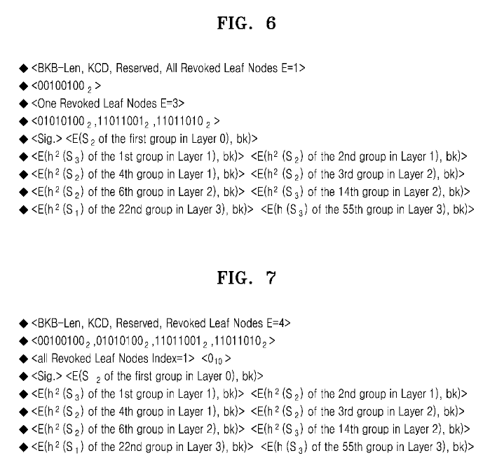

FIG. 6 illustrates a key block constructed to restrict the use of the content of the revoked nodes of the BE system illustrated in FIG. 3, according to an exemplary embodiment of the present invention.

In FIG. 6, “All Revoked Leaf Nodes E=1” indicates that the number of revoked node groups is 1, and <00100100₂> indicates the identifier of the revoked node group, that is, the identifier 0210 in Table 1. In fact, the identifier <00100100₂>, namely, 0210, is the identifier of a first revoked node, namely, a revoked node located at the first position in the revoked node group. However, in the present exemplary embodiment, the identifier of the first revoked node located at the first position in the revoked node group is used as the identifier of the revoked node group. However, the identifier of the revoked node group may be represented in the other ways, such as by using the identifier of a node other than the first revoked node among the revoked nodes belonging to the revoked node group.

<One Revoked Leaf Nodes E=3> indicates that the number of independent revoked nodes is 3, and <01010100₂, 11011001₂, 11011010₂> indicates the identifiers of the three independent revoked nodes.

As described above, in the present invention, the number of revoked node groups and the identifiers of the revoked node groups are indicated independently from the number of independent revoked nodes and the identifiers of the independent revoked nodes, respectively. Thus, the present invention does not need to use tags.

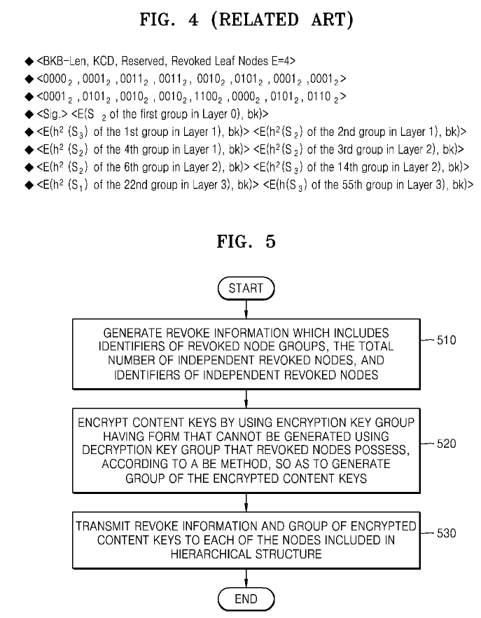

In the related art illustrated in FIG. 4, the identifiers of revoked nodes are marked according to the layers of a hierarchy. For example, a first row 00010303 of Table 1 is indicated as 0000₂, 0001₂, 0011₂, 0011₂. However, in the exemplary embodiments of the present invention illustrated in FIG. 6, the identifiers of a revoked node group and revoked nodes on the second, fourth, sixth, and eighth columns of Table 1 are represented with binary numbers. Accordingly, a smaller key block can be created in the present invention than in the related art, and it is more convenient to recognize the identifiers of revoked nodes in the present invention than in the related art. Although the identifiers in the present exemplary embodiment are represented with binary numbers, the present invention is not limited to binary numbers. In other words, the identifiers may be represented with a quaternary number, a hexadecimal number, or the like. The key block of FIG. 6 has the same components as that of the one of FIG. 4 except for the above-described difference, so a detailed description thereof will be omitted.

FIG. 7 illustrates a key block constructed to restrict the use of content by the revoked nodes of the BE system illustrated in FIG. 3, according to another exemplary embodiment of the present invention.

In FIG. 7, “Revoked Leaf Nodes E=4” indicates that the total number of revoked nodes is 4, and <00100100₂, 01010100₂, 11011001₂, 11011010₂> indicates the identifiers of the 4 revoked nodes, which are not distinguished between an independent revoked node and a revoked node group. Such an identifier list including the identifiers of independent revoked nodes and the identifiers of revoked node groups can be created by integrating the identifiers of independent revoked nodes and the identifiers of revoked node groups with one another.

<all revoked leaf Nodes Index=1> indicates that the total number of revoked node groups is 1, and <0₁₀> denotes an index that indicates that a first identifier in the identifier list is the identifier of the revoked node group.

FIG. 8 is a block diagram of a content key transmitting apparatus according to an exemplary embodiment of the present invention. Referring to FIG. 8, the content key transmitting apparatus includes a revoke information generation unit 810, a key generation unit 820, and a transmission unit 830.

The revoke information generation unit 810 generates revoke information that includes identifiers of revoked node groups, the total number of independent revoked nodes, and the identifiers of the independent revoked nodes. As described above, the revoke information generation unit 810 may generate revoke information that includes the total number of revoked node groups, in addition to the above-described pieces of information.

The key generation unit 820 encrypts content keys by using an encryption key group having a form that cannot be generated using a decryption key group that the revoked nodes possess, according to a BE method, thereby generating a group of the encrypted content keys. The group of the encrypted content keys is generated according to this way in order to prevent a content key from being obtained from encrypted content keys even when revoked nodes receive the encrypted content keys.

The transmission unit 830 transmits the revoke information and the group of encrypted content keys to each of the nodes arranged in a hierarchical structure.

As described above, the transmission unit 830 may further transmit key check data (KCD), which are hash values of the content keys, information about the length of data, and an electronic signature for both the KCD and the data length information.

Furthermore, the revoke information and the group of encrypted content keys may be transmitted separately, but a key block including the revoke information and the group of encrypted content keys may be transmitted to each of the nodes.

In other exemplary embodiments, the content key transmitting apparatus may further include a node detection unit (not shown) for detecting revoked nodes from the nodes arranged in the hierarchical structure. The revoke information generation unit 810 and the key generation unit 820 may perform their operations based on a result of the detection performed by the node detection unit.

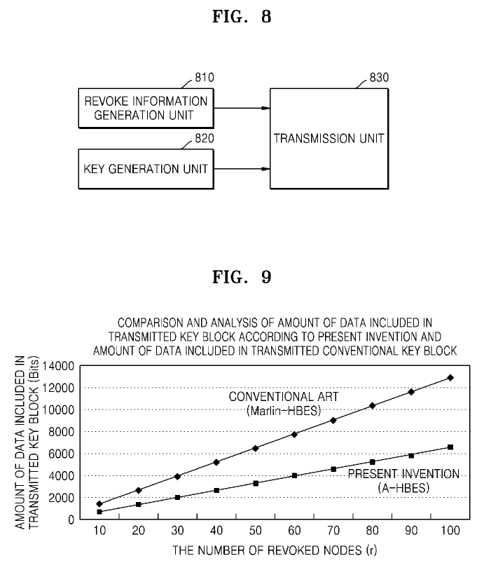

FIG. 9 illustrates a difference between the amount of data included in a transmitted key block according to the present invention and the amount of data included in a transmitted related art key block, according to the number of revoked nodes.

Referring to FIG. 9, as the number of revoked nodes increases, a difference between the amount of data of a key bock according to the present invention transmitted to each node and that of data of a related art key block transmitted to each node increases. Here, the amount of data of the transmitted key bock according to the present invention is always less than that of data of the transmitted related art key block.

In the present invention, a content key can be transmitted to nodes included in a BE system by using a smaller key block as compared with that in the related art.

The exemplary embodiments of the present invention can be written as computer programs and can be implemented in general-use digital computers that execute the programs recorded on a computer readable recording medium. Examples of the computer readable recording medium include magnetic storage media (e.g., ROM, floppy disks, hard disks, etc.), and optical recording media (e.g., CD-ROMs, or DVDs).

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of transmitting content keys to nodes arranged in a hierarchical structure which comprises a plurality of node groups each comprising a predetermined number of the nodes, the method comprising:
generating revoke information that comprises identifiers of revoked node groups in the hierarchical structure, a total number of independent revoked nodes, and identifiers of the independent revoked nodes, wherein the revoked node groups are node groups consisting of only revoked nodes and the independent revoked nodes are revoked nodes not belonging to any of the revoked node groups;
generating a set of encrypted content keys that are obtained by encrypting content keys using broadcast encryption, by using an encryption key set that has a form that cannot be generated using a decryption key set that the revoked nodes possess; and
transmitting the revoke information and the set of the encrypted content keys to all of the nodes arranged in the hierarchical structure.

2. The method of claim 1, wherein the generating the revoke information further comprises:
generating a single identifier list by integrating the identifiers of the independent revoked nodes with the identifiers of the revoked node groups; and
generating indices that represent orders in which the identifiers of the revoked node groups are located within the identifier list; and
wherein the revoke information comprises the identifier list, the indices, and a total number of revoked nodes.

3. The method of claim 1, wherein the revoke information further comprises the total number of revoked node groups; and
the total number of independent revoked nodes represents a number of revoked nodes other than revoked nodes belonging to the revoked node groups.

4. The method of claim 1, wherein the identifier of each of the revoked node groups is generated using an identifier of a revoked node from among the revoked nodes that constitute each of the revoked node groups.

5. The method of claim 1, wherein each of the node groups is comprised of N nodes, and the generating the revoke information comprises:
sequentially allocating numbers 0 through (N−1) to the N nodes of each of the node groups in each layer of the hierarchical structure; and
generating the identifiers of the revoked node groups and the identifiers of the independent revoked nodes by combining numbers allocated to all of the nodes on an uppermost layer through to a lowermost layer of the hierarchical structure so that a number allocated to the uppermost layer through a number allocated to the lowermost layer are sequentially combined.

6. The method of claim 1, wherein the transmitting comprises transmitting key check data, which is hash values of the content keys, the revoke information, the set of the encrypted content keys, data length information representing an overall length of the key check data, and an electronic signature for the key check data, the revoke information, and the data length information.

7. The method of claim 1, further comprising detecting revoked nodes from the nodes arranged in the hierarchical structure.

8. The method of claim 1, wherein if the nodes have been allocated with random node keys, the encryption key set is comprised of encryption keys obtained by performing a smaller number of hash operations on identical random node keys which is less than a number of hash operations performed to obtain decryption keys included in the decryption key group.

9. The method of claim 1, wherein the identifiers of the revoked node groups, the total number of independent revoked nodes, and the identifiers of the independent revoked nodes are generated by using one of a binary number, a quaternary number, and a hexadecimal number.

10. The method of claim 1, wherein the transmitting comprises transmitting a key block comprising the revoke information and the set of the encrypted content keys to all of the nodes arranged in the hierarchical structure.

11. An apparatus for transmitting content keys to nodes arranged in a hierarchical structure which includes a plurality of node groups each comprising a predetermined number of the nodes, the apparatus comprising:
a revoke information generation unit which generates revoke information that comprises identifiers of revoked node groups in the hierarchical structure, a total number of independent revoked nodes, and identifiers of the independent revoked nodes, wherein the revoked node groups are node groups consisting of only revoked nodes and the independent revoked nodes are revoked nodes not belonging to any of the revoked node groups;
a key generation unit generating a set of encrypted content keys that are obtained by encrypting content keys using broadcast encryption, by using an encryption key set that has a form that cannot be generated using a decryption key set that the revoked nodes possess; and
a transmission unit transmitting the revoke information and the set of the encrypted content keys to all of the nodes arranged in the hierarchical structure.

12. The apparatus of claim 11, wherein the revoke information generation unit further generates a single identifier list by integrating the identifiers of the independent revoked nodes with the identifiers of the revoked node groups, generates indices that represent orders in which the identifiers of the revoked node groups are located within the identifier list, and generates revoke information comprising the identifier list, the indices, and a total number of revoked nodes.

13. The apparatus of claim 11, wherein the revoke information further comprises a total number of revoked node groups; and
the total number of independent revoked nodes represents a number of revoked nodes other than revoked nodes belonging to the revoked node groups.

14. The apparatus of claim 11, wherein the identifier of each of the revoked node groups is generated using an identifier of a revoked node from among the revoked nodes that constitute each of the revoked node groups.

15. The apparatus of claim 11, wherein each of the node groups is comprised of N nodes, and the revoke information generation unit sequentially allocates numbers 0 through (N−1) to the N nodes of each of the node groups in each layer of the hierarchical structure, and generates the identifiers of the revoked node groups and the identifiers of the independent revoked nodes by combining numbers allocated to all of the nodes on an uppermost layer through to a lowermost layer of the hierarchical structure so that a number allocated on the uppermost through a number allocated on the lowermost layer are sequentially combined.

16. The apparatus of claim 11, wherein the transmission unit further transmits key check data, which is hash values of the content keys, the revoke information, the set of the encrypted content keys, data length information representing an overall length of the key check data, and an electronic signature for the key check data, the revoke information, and the data length information.

17. The apparatus of claim 11, further comprising a node detection unit detecting revoked nodes from the nodes arranged in the hierarchical structure.

18. The apparatus of claim 11, wherein if the nodes have been allocated with random node keys, the encryption key set is comprised of encryption keys obtained by performing a number of hash operations on identical random node keys which is less than a number of hash operations performed to obtain decryption keys included in the decryption key group.

19. The apparatus of claim 11, wherein the identifiers of the revoked node groups, the total number of independent revoked nodes, and the identifiers of the independent revoked nodes are generated by using one of a binary number, a quaternary number, and a hexadecimal number.

20. A computer-readable recording medium having recorded thereon a program for executing the method of claim 1.
